(19) United States
(12) Patent Application Publication
(10) Pub. No.: US 2025/0187149 A1
(43) Pub. Date: Jun. 12, 2025

(54) METHODS AND MACHINE TOOL ASSEMBLIES FOR PERFORMING OPERATIONS ON WORKPIECES AND GRIPPER ATTACHMENTS FOR MACHINE TOOL ASSEMBLIES

(71) Applicant: The Boeing Company, Arlington, VA (US)

(72) Inventors: Doan D. Pham, Lacey, WA (US); Derek A. Goetz, Puyallup, WA (US)

(73) Assignee: The Boeing Company, Arlington, VA (US)

(21) Appl. No.: 18/535,154

(22) Filed: Dec. 11, 2023

(51) Int. Cl. B25B 11/00; B23B 35/00; B23B 47/34

(52) U.S. Cl. CPC B25B 11/005; B23B 35/00; B23B 47/34

(57) ABSTRACT

A method for performing an operation on a workpiece includes moving a machine tool assembly to a desired location on a work surface of the workpiece, the machine tool assembly defines a proximal end and a distal end and includes a gripper attachment affixed to the distal end, the gripper attachment includes a conformable foam seal opposing the work surface; activating a vacuum source to draw a vacuum on the work surface through the conformable foam seal and the gripper attachment; and vacuum clamping the machine tool assembly to the work surface at the desired location in response to the vacuum drawn on the work surface. The machine tool assembly includes a machine tool and the gripper attachment. The machine tool includes a housing, a rotational drive, a drive shaft and a bit clamp. The gripper attachment includes a body, a cover and a conformable foam seal.

### FIELD

The present disclosure relates generally to techniques for performing operations on workpieces and, particularly, to vacuum clamping a machine tool assembly to a work surface of the workpiece during such operations. A gripper attachment on the machine tool assembly facilitates the vacuum clamping. Power drill assemblies and power driver assemblies are contemplated for the machine tool assemblies. The operations contemplated include drilling holes in the workpiece and removing fasteners. Templates are contemplated in conjunction with drilling holes. In such examples, the template is vacuum clamped to the work surface along with the power drill assembly. Use of machine tool assemblies as end effectors of articulated robots, including collaborative robots, is also contemplated. The various examples also contemplate the use of handheld machine tool assemblies.

### BACKGROUND

Current techniques for performing operations on a workpiece often use a template secured to a work surface of the workpiece and a template foot attached to a machine tool assembly suitable for performing the operation. The template foot locks into a hole in the template and the machine tool assembly uses a collet in an adjacent hole in the template to drill a hole in the workpiece. The template is typically indexed to the workpiece but not secured to the work surface.

Accordingly, those skilled in the art continue with research and development efforts to improve techniques for securing machine tool assemblies to work surfaces of workpieces while performing operations on the workpieces.

### SUMMARY

Disclosed are examples of methods for performing an operation on a workpiece, machine tool assemblies for performing an operation on a workpiece and gripper attachments for machine tool assemblies. The following is a non-exhaustive list of examples, which may or may not be claimed, of the subject matter according to the present disclosure.

In an example, the disclosed method for performing an operation on a workpiece includes: (1) moving a machine tool assembly to a desired location on a work surface of the workpiece, the machine tool assembly defining a proximal end and a distal end and including a gripper attachment affixed to the distal end, the gripper attachment including a conformable foam seal opposing the work surface; (2) activating a vacuum source to draw a vacuum on the work surface through the conformable foam seal and the gripper attachment; and (3) vacuum clamping the machine tool assembly to the work surface at the desired location in response to the vacuum drawn on the work surface.

In an example, the disclosed machine tool assembly for performing an operation on a workpiece includes a machine tool and a gripper attachment. The machine tool includes a housing, a rotational drive, a drive shaft and a bit clamp. The housing defines a first proximal end and a first distal end. The rotational drive disposed within the housing to selectively provide a rotational force. The drive shaft coupled to the rotational drive selectively rotates in response to the rotational force from the rotational drive. The bit clamp attached to the drive shaft rotates in response to the rotational force. The clamp is configured to selectively receive and secure a working bit. The gripper attachment affixed to the first distal end of the housing for the machine tool. The gripper attachment includes a body, a cover and a conformable foam seal. The body defines a central bore and a seal vacuum compartment. The central bore along a longitudinal axis extending from a second proximal end of the body to a second distal end. The seal vacuum compartment isolated from the central bore and defining a seal vacuum port extending through the second proximal end of the body. The seal vacuum compartment further defines an opening proximate the second distal end of the body that encircles the central bore. The central bore receives the bit clamp of the machine tool at the second proximal end of the body and provides a clearance fit that permits rotation of the bit clamp within the central bore. The cover attached to the body over the opening of the seal vacuum compartment. The cover defining a plurality of apertures dispersed about an area of the cover over the opening to the seal vacuum compartment. The conformable foam seal attached to the cover over the plurality of apertures. The conformable foam seal defines a hole aligned with the central bore to provide a clearance fit for the bit clamp.

In an example, the disclosed gripper attachment for a machine tool assembly includes a body, a cover and a conformable foam seal. The body defines a central bore and a seal vacuum compartment. The central bore along a longitudinal axis extending from a proximal end of the body to a distal end. The seal vacuum compartment isolated from the central bore and defining a seal vacuum port extending through the proximal end of the body. The seal vacuum compartment further defines an opening proximate the distal end of the body that encircles the central bore. The central bore is configured to receive a bit clamp on a machine tool of the machine tool assembly at the proximal end of the body and providing a clearance fit that permits rotation of the bit clamp within the central bore. The bit clamp configured to selectively receive and secure a working bit. The cover attached to the body over the opening of the seal vacuum compartment. The cover defining a plurality of apertures dispersed about an area of the cover over the opening to the seal vacuum compartment. The conformable foam seal attached to the cover over the plurality of apertures and configured to face a work surface of a workpiece upon which the machine tool assembly is configured to perform an operation, the conformable foam seal defining a hole aligned with the central bore to provide a clearance fit for the bit clamp.

Other examples of the disclosed methods for performing an operation on a workpiece, machine tool assemblies for performing an operation on a workpiece and gripper attachments for machine tool assemblies will become apparent from the following detailed description, the accompanying drawings and the appended claims.

### BRIEF DESCRIPTION OF THE DRAWINGS

FIG. 1 is a flow diagram of an example of a method for performing an operation on a workpiece;

FIG. 2 is a flow diagram of an example of the vacuum clamping of the machine tool assembly to the work surface in the method of FIG. 1;

FIG. 3 is a flow diagram of another example of the vacuum clamping of the machine tool assembly to the work surface in the method of FIG. 1;

FIG. 4, in combination with FIGS. 1 and 3, is a flow diagram of another example of a method for performing an operation on a workpiece;

FIG. 5 is a flow diagram showing examples of the moving of a machine tool assembly to a desired location and the activating of a vacuum source in the method of FIG. 1;

FIG. 6, in combination with FIGS. 1 and 5, is a flow diagram of yet another example of a method for performing an operation on a workpiece;

FIG. 7 is a flow diagram showing examples of the moving of a machine tool assembly to a desired location and the vacuum clamping of the machine tool assembly to the work surface in the method of FIG. 1;

FIG. 8, in combination with FIG. 1, is a flow diagram of still another example of a method for performing an operation on a workpiece;

FIG. 9 is a flow diagram showing further examples of the moving of a machine tool assembly to a desired location and the vacuum clamping of the machine tool assembly to the work surface in the method of FIG. 1;

FIG. 10, in combination with FIG. 1, is a flow diagram of still yet another example of a method for performing an operation on a workpiece;

FIG. 11 is a perspective view of an example of a machine tool assembly for performing an operation on a workpiece that includes a machine tool and a gripper attachment;

FIG. 12 is a plan view showing portions of templates on a work surface of a workpiece in conjunction with performing an operation on the workpiece;

FIG. 13 is a side view of an example of a machine tool in the machine tool assembly of FIG. 11;

FIG. 14 is another side view of the machine tool of FIG. 13 showing an example of a sleeve that fits over a bit clamp with a working bit;

FIG. 15 is a cross-sectional view of an example of the gripper attachment of FIG. 11;

FIG. 16 is a perspective view of an example of an articulated robot with the machine tool assembly of FIG. 1 on an end effector attached to a robotic arm;

FIG. 17 is a functional block diagram of an example of the gripper assembly of FIG. 11 interconnected to seal and chip vacuum sources and posed facing a workpiece;

FIG. 18 is a block diagram of aircraft production and service methodology that implements one or more of the examples of methods for performing an operation on a workpiece disclosed herein to produce or maintain components of the aircraft; and

FIG. 19 is a schematic illustration of an aircraft that incorporates one or more examples of components produced or maintained using machine tool assemblies with gripper attachments disclosed herein.

### DETAILED DESCRIPTION

The various examples of methods for performing an operation on a workpiece and machine tool assemblies with gripper attachments disclosed herein provide a proper vacuum clamp up to secure the machine tool assembly to the work surface of a workpiece. If a template is used on the workpiece, the vacuum clamp up also secures the template to the work surface. If an articulated robot or a collaborative robot is used, the machine tool assembly with the gripper attachment includes an end effector attached to a robotic arm. With the robot in a hand guiding mode, the vacuum clamp up makes fine adjustment to the position of the robotic arm and the machine tool assembly in relation to the work surface.

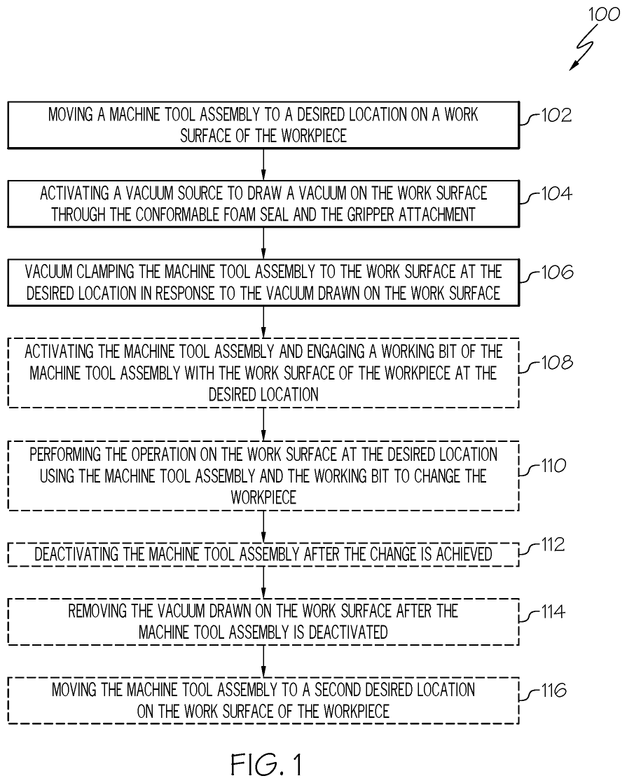

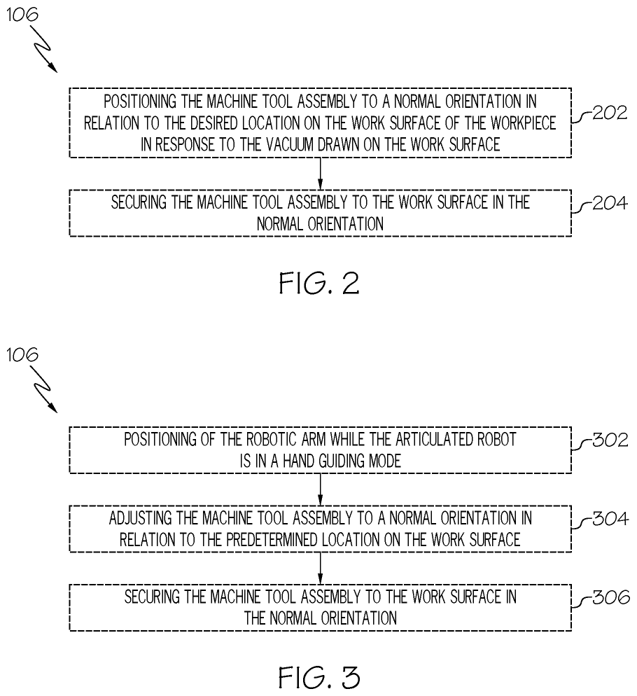

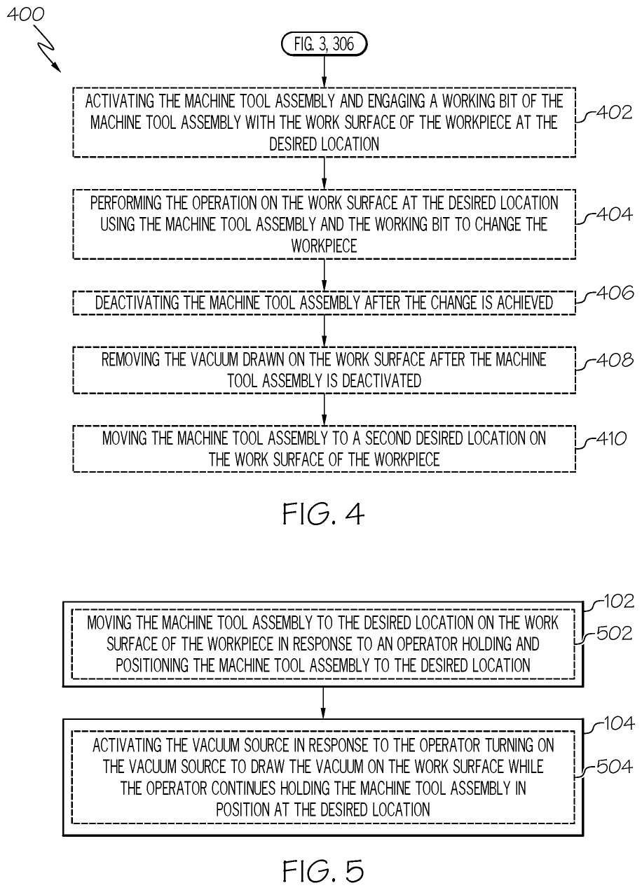

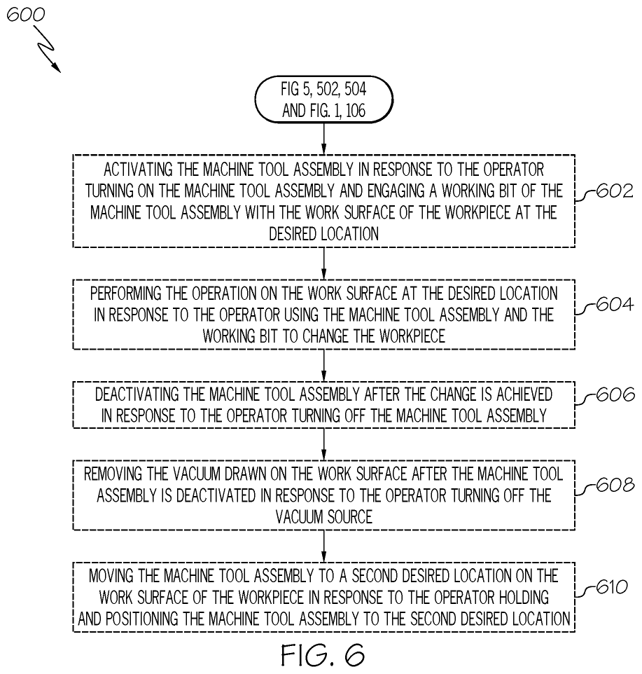

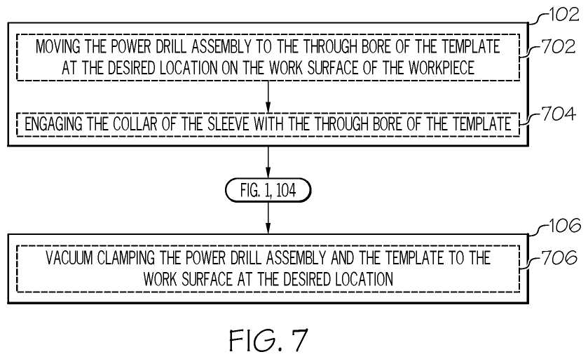

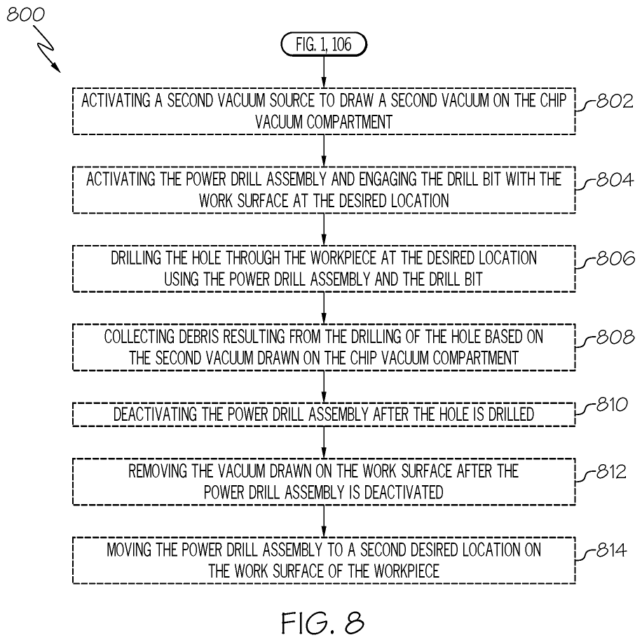

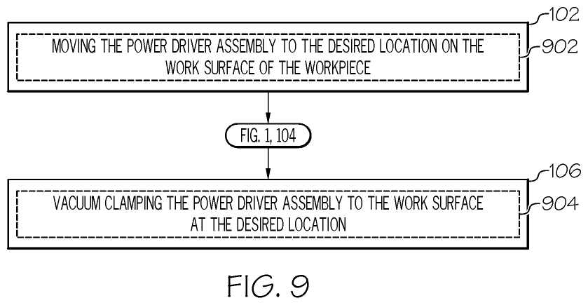

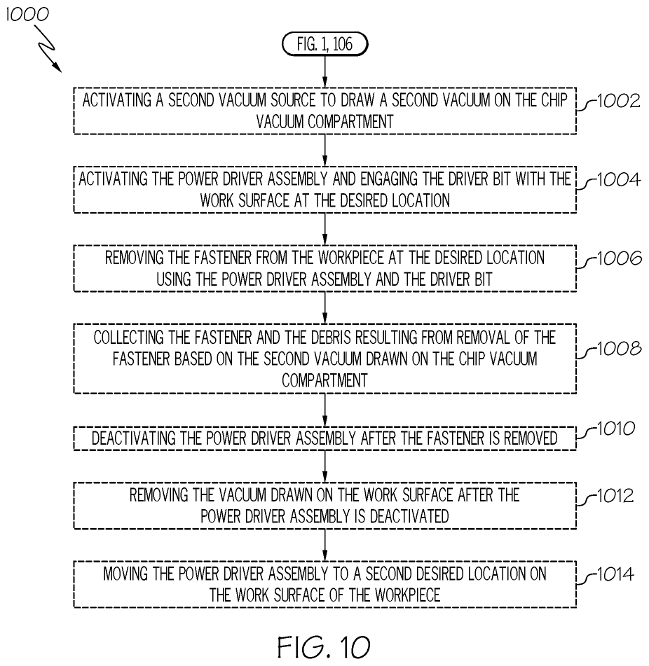

Referring generally to FIGS. 1-17, by way of examples, the present disclosure is directed to a method 100, 400, 600, 800, 1000 for performing an operation on a workpiece 1202. FIG. 1 discloses an example of the method 100 for performing an operation on a workpiece 1202. FIG. 2 discloses an example of the vacuum clamping 106 of the machine tool assembly 1100 to the work surface 1206 from the method 100 of FIG. 1. FIG. 3 discloses another example of the vacuum clamping 106 of the machine tool assembly 1100 to the work surface 1206 from the method 100 of FIG. 1. FIG. 4, in combination with FIGS. 1 and 3, discloses an example of the method 400 for performing an operation on a workpiece 1202. FIG. 5 discloses examples of the moving 102 of a machine tool assembly 1100 and the activating 104 of a vacuum source 1702 from the method 100 of FIG. 1. FIG. 6, in combination with FIGS. 1 and 5, discloses an example of the method 600 for performing an operation on a workpiece 1202. FIG. 7 discloses examples of the moving 102 of a machine tool assembly 1100 and the vacuum clamping 106 of the machine tool assembly 1100 to the work surface 1206 from the method 100 of FIG. 1. FIG. 8, in combination with FIG. 1, discloses an example of the method 800 for performing an operation on a workpiece 1202. FIG. 9 discloses examples of the moving 102 of a machine tool assembly 1100 and the vacuum clamping 106 of the machine tool assembly 1100 to the work surface 1206 from the method 100 of FIG. 1. FIG. 10, in combination with FIG. 1, discloses an example of the method 1000 for performing an operation on a workpiece 1202.

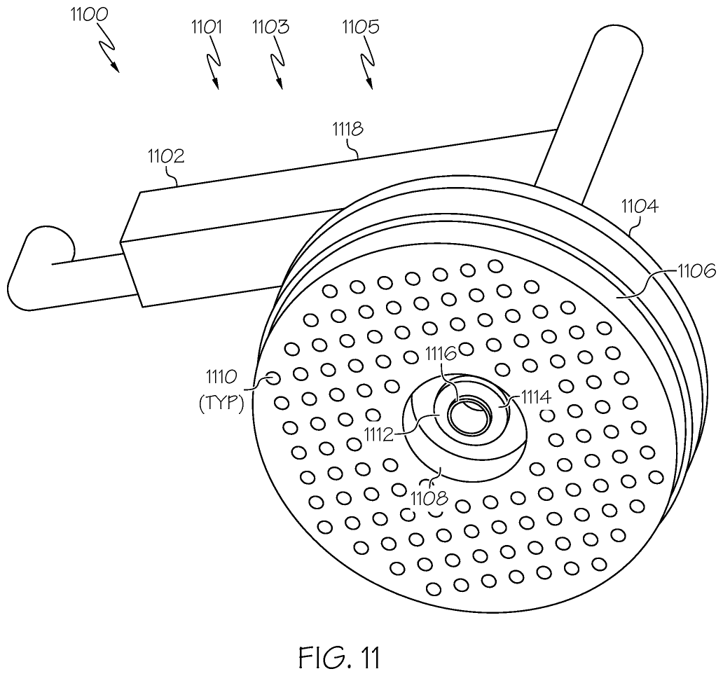

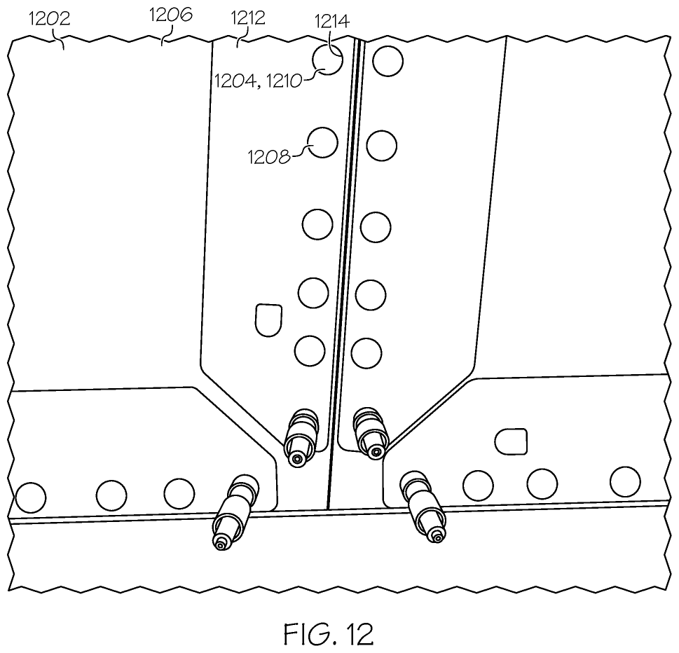

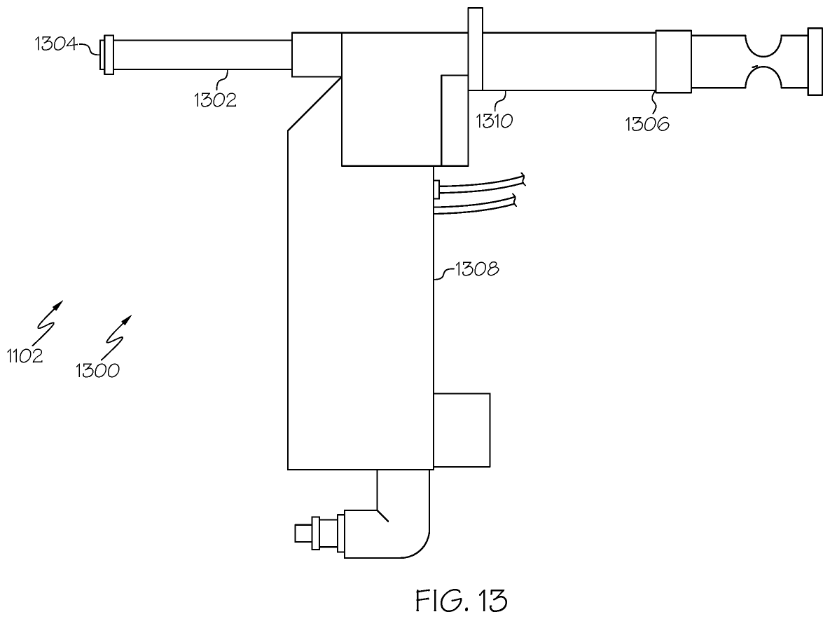

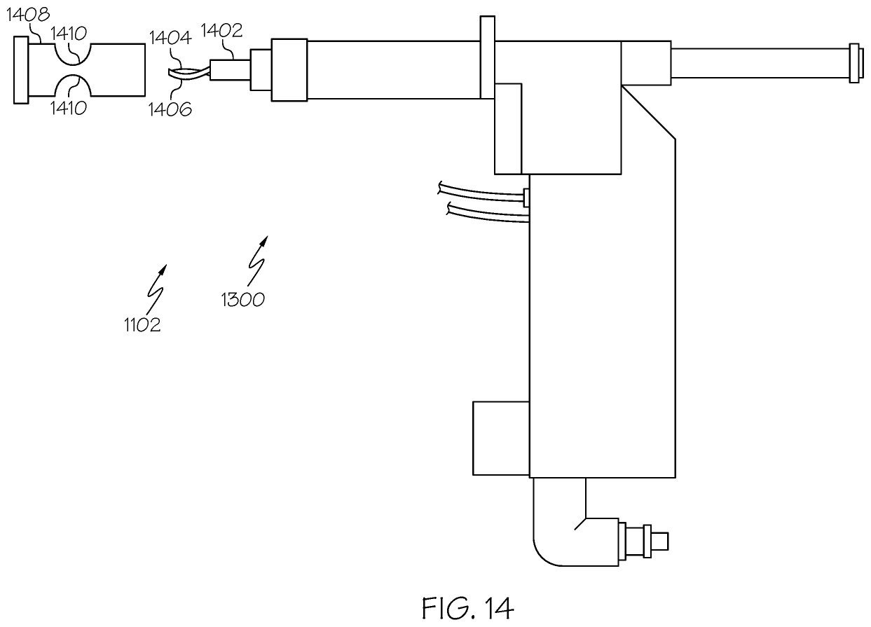

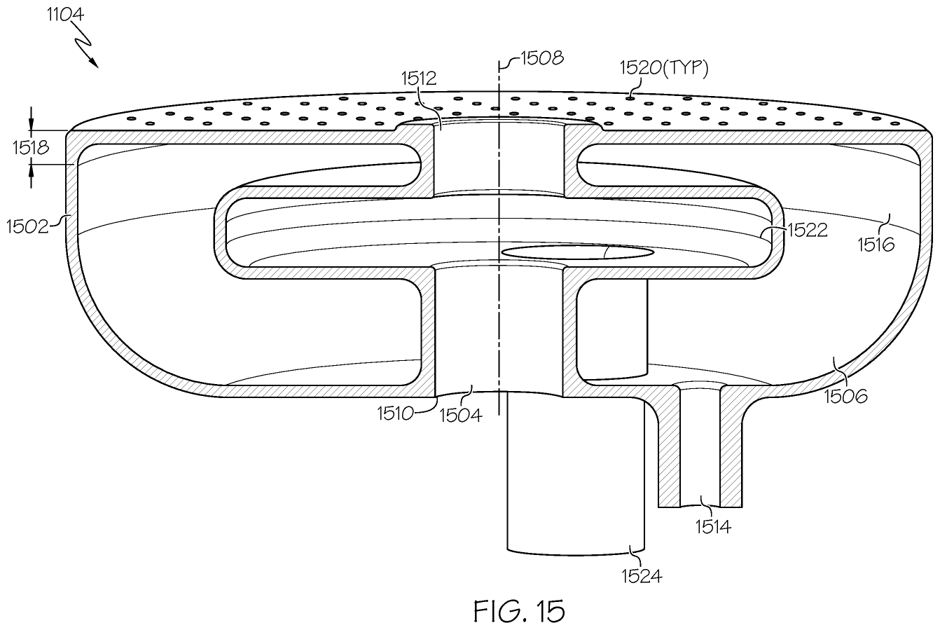

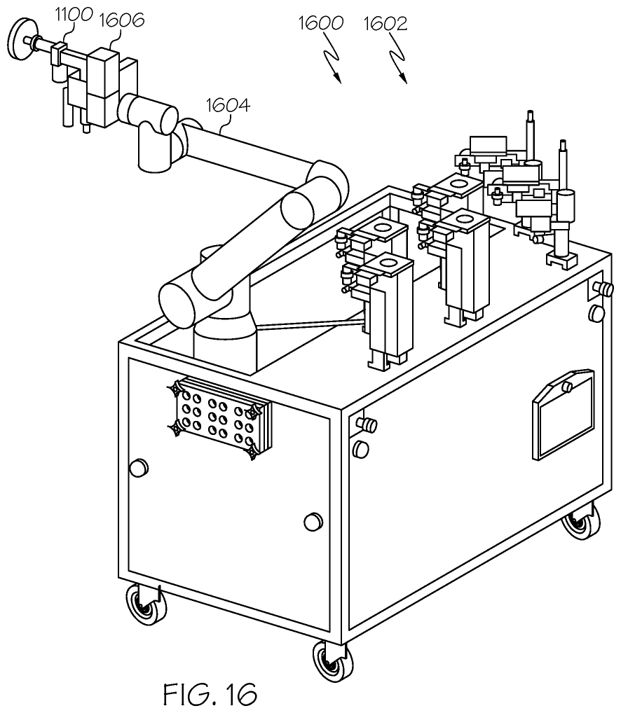

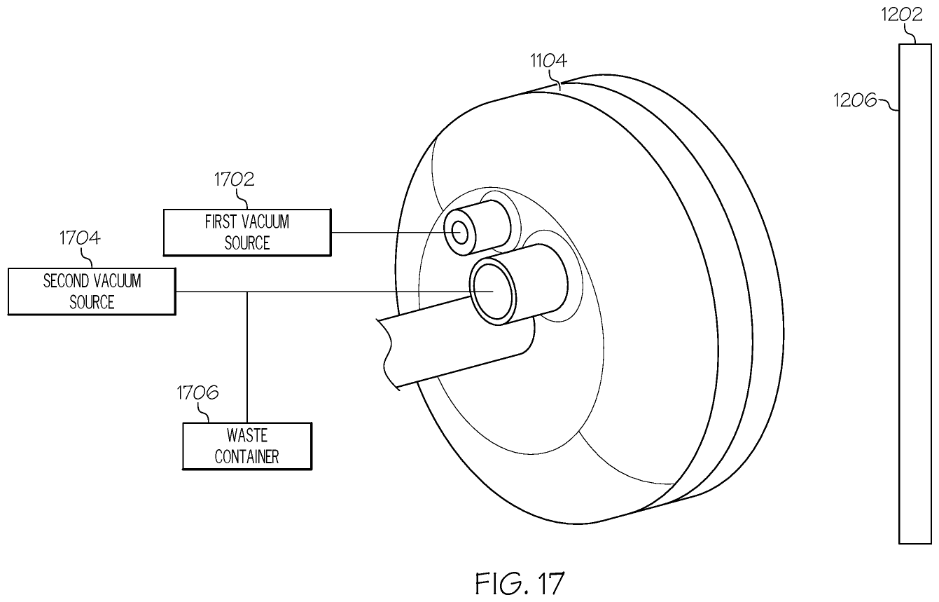

FIG. 11 is a perspective view of an example of the machine tool assembly 1100 with a machine tool 1102 and a gripper attachment 1104. FIG. 12 is a plan view showing portions of templates 1212 on a work surface 1206 of a workpiece 1202. FIG. 13 is a side view of an example of a machine tool 1102 of the machine tool assembly 1100. FIG. 14 is another side view of the machine tool 1102 showing an example of a sleeve 1408 that fits over a bit clamp 1402 with a working bit 1404. FIG. 15 is a cross-sectional view of an example of the gripper attachment 1104. FIG. 16 is a perspective view of an example of an articulated robot 1600 with the machine tool assembly 1100 on an end effector 1606 attached to a robotic arm 1604. FIG. 17 discloses a functional block diagram showing an example of the gripper attachment 1104 interconnected to a first (i.e., seal) vacuum source 1702 and a second (i.e., chip) vacuum source 1704 and posed facing the workpiece 1202.

With reference again to FIGS. 1 and 11-17, in one or more examples, a method 100 (see FIG. 1) for performing an operation on a workpiece 1202 includes moving 102 a machine tool assembly 1100 to a desired location 1204 on a work surface 1206 of the workpiece 1202. The machine tool assembly 1100 defining a proximal end 1304 and a distal end 1306 and including a gripper attachment 1104 affixed to the distal end 1306. The gripper attachment 1104 includes a conformable foam seal 1106 opposing the work surface 1206. At 104, a vacuum source 1702 is activated to draw a vacuum on the work surface 1206 through the conformable foam seal 1106 and the gripper attachment 1104. At 106, the machine tool assembly 1100 is vacuum clamped to the work surface 1206 at the desired location 1204 in response to the vacuum drawn on the work surface 1206.

In another example of the method 100, the operation to be performed on the workpiece 1202 includes drilling a hole, removing a fastener or any other suitable operation. In yet another example of the method 100, the workpiece 1202 includes a composite workpiece, a metal workpiece or any other suitable workpiece in any suitable combination. In still another example of the method 100, the machine tool assembly 1100 includes a power drill assembly 1103, a power driver assembly 1105 or any other suitable machine tool assembly. In still yet another example of the method 100, the work surface 1206 of the workpiece 1202 includes a curved portion, a double curved portion, a contoured portion, a geometrically-shaped portion, a rising ramp portion, a falling ramp portion, a two-dimensional portion or any other suitable shaped portion in any suitable combination.

In another example of the method 100, the conformable foam seal 1106 includes an open cell foam, a closed cell foam or any other suitable conformable foam in any suitable combination. In a further example, the open cell foam includes a polyurethane foam, a reticulated polyurethane foam, an open cell nitrile foam, an open cell polyvinyl chloride/nitrile foam, an open cell ethylene propylene diene monomer foam or any other suitable open cell foam in any suitable combination. In another further example, the closed cell foam includes a polyethylene foam, a polyvinyl chloride foam rubber, a closed cell polyvinyl chloride/nitrile foam, a closed cell ethylene propylene diene monomer foam rubber, an ethylene-vinyl acetate foam, an expanded polyethylene foam, a cross-linked polyethylene foam, a styrene butadiene rubber foam or any other suitable closed cell foam in any suitable combination. In yet another further example, where the conformable foam seal 1106 includes the closed cell foam, the conformable foam seal 1106 also includes a plurality of apertures 1110 facing the work surface 1206 of the workpiece 1202 and aligned with a second plurality of apertures 1520 associated with a seal vacuum compartment 1506 of the gripper attachment 1104.

In yet another example of the method 100, the vacuum source 1702 includes a vacuum pump, a vacuum line to a facility vacuum system or any other suitable vacuum source in any suitable combination. In still another example of the method 100, the gripper attachment 1104 defines a seal vacuum compartment 1506 in fluid communication with the vacuum source 1702 and the conformable foam seal 1106 in conjunction with drawing the vacuum on the work surface 1206.

In still yet another example, the method 100 also includes activating 108 the machine tool assembly 1100 and engaging a working bit 1404 of the machine tool assembly 1100 with the work surface 1206 of the workpiece 1202 at the desired location 1204. At 110, the operation is performed on the work surface 1206 at the desired location 1204 using the machine tool assembly 1100 and the working bit 1404 to change the workpiece 1202. In a further example, the working bit 1404 includes a drill bit 1406, a cutting bit, a trimming bit, a routing bit, a sanding bit, a polishing bit, a driver bit or any other suitable working bit.

In another example, the method 100 also includes deactivating 112 the machine tool assembly 1100 after the change is achieved. At 114, the vacuum drawn on the work surface 1206 is removed after the machine tool assembly 1100 is deactivated. At 116, the machine tool assembly 1100 is moved to a second desired location 1208 on the work surface 1206 of the workpiece 1202. In another example of the method 100, the vacuum clamping 106 of the machine tool assembly 1100 includes positioning 202 (see FIG. 2) the machine tool assembly 1100 to a normal orientation in relation to the desired location 1204 on the work surface 1206 of the workpiece 1202 in response to the vacuum drawn on the work surface 1206. At 204, the machine tool assembly 1100 is secured to the work surface 1206 in the normal orientation.

In yet another example of the method 100, the machine tool assembly 1100 includes an end effector 1606 attached to a robotic arm 1604 of an articulated robot 1600. In this example, the desired location 1204 includes a predetermined location 1210 known to the articulated robot 1600 and the vacuum clamping 106 of the machine tool assembly 1100 includes positioning 302 (see FIG. 3) of the robotic arm 1604 while the articulated robot 1600 is in a hand guiding mode. At 304, the machine tool assembly 1100 is adjusted to a normal orientation in relation to the predetermined location 1210 on the work surface 1206. At 306, the machine tool assembly 1100 is secured to the work surface 1206 in the normal orientation. In a further example, the articulated robot 1600 includes a collaborative robot 1602.

With reference again to FIGS. 1, 4, 11, 12 and 14, in one or more examples, a method 400 (see FIG. 4) for performing an operation on a workpiece 1202 includes the method 100 of FIGS. 1 and 3. The method 400 continues from 306 of FIGS. 3 to 402 where the machine tool assembly 1100 is activated and a working bit 1404 of the machine tool assembly 1100 is engaged with the work surface 1206 of the workpiece 1202 at the desired location 1204. At 404, the operation is performed on the work surface 1206 at the desired location 1204 using the machine tool assembly 1100 and the working bit 1404 to change the workpiece 1202. At 406, the machine tool assembly 1100 is deactivated after the change is achieved. At 408, the vacuum drawn on the work surface 1206 is removed after the machine tool assembly 1100 is deactivated. At 410, the machine tool assembly 1100 is moved to a second desired location 1208 on the work surface 1206 of the workpiece 1202.

With reference again to FIGS. 1, 5, 11, 12 and 17, in still another example of the method 100, the machine tool assembly 1100 includes a handheld machine tool assembly 1101. In this example, the moving 102 of the machine tool assembly 1100 includes moving 502 (see FIG. 5) the handheld machine tool assembly 1101 to the desired location (1204) on the work surface 1206 of the workpiece 1202 in response to an operator holding and positioning the handheld machine tool assembly 1101 to the desired location 1204. Here, the activating 104 of the vacuum source 1702 includes activating 504 the vacuum source 1702 in response to the operator turning on the vacuum source 1702 to draw the vacuum on the work surface 1206 while the operator continues holding the handheld machine tool assembly 1101 in position at the desired location 1204.

With reference again to FIGS. 1, 5, 6, 11, 12, 14 and 17, in one or more examples, a method 600 (see FIG. 6) for performing an operation on a workpiece 1202 includes the method 100 of FIGS. 1 and 5. The method 600 continues from 106 of FIGS. 1 and 502 and 504 of FIGS. 5 3 to 602 where the handheld machine tool assembly 1101 is activated in response to the operator turning on the handheld machine tool assembly 1101 and a working bit 1404 of the handheld machine tool assembly 1101 is engaged with the work surface 1206 of the workpiece 1202 at the desired location 1204. At 604, the operation is performed on the work surface 1206 at the desired location 1204 in response to the operator using the handheld machine tool assembly 1101 and the working bit 1404 to change the workpiece 1202. At 606, the handheld machine tool assembly 1101 is deactivated after the change is achieved in response to the operator turning off the handheld machine tool assembly 1101. At 608, the vacuum drawn on the work surface 1206 is removed after the handheld machine tool assembly 1101 is deactivated in response to the operator turning off the vacuum source 1702. At 610, the handheld machine tool assembly 1101 is moved to a second desired location 1208 on the work surface 1206 of the workpiece 1202 in response to the operator holding and positioning the handheld machine tool assembly 1101 to the second desired location 1208.

With reference again to FIGS. 11-15, in still another example of the method 100, the machine tool assembly 1100 includes a power drill assembly 1103 and the operation to be performed on the workpiece 1202 includes drilling a hole at the desired location 1204. The power drill assembly 1103 includes a power drill 1300 with a bit clamp 1402 configured to selectively receive and secure a drill bit 1406. The power drill assembly 1103 also includes a sleeve 1408 attached to the power drill 1300 over the bit clamp 1402. The sleeve 1408 providing a clearance fit to permit rotation of the bit clamp 1402. In this example, the gripper attachment 1104 defines a central bore 1504 extending from a second proximal end 1510 of the gripper attachment 1104 to a second distal end 1512 and a chip vacuum compartment 1522 in fluid communication with the central bore 1504. The central bore 1504 receiving the sleeve 1408 of the power drill assembly 1103. The sleeve 1408 includes multiple openings 1410 that provide fluid paths to the chip vacuum compartment 1522 for debris resulting from the operation performed on the workpiece 1202. The conformable foam seal 1106 defines a hole 1108 aligned with the central bore 1504 of the gripper attachment 1104 to provide a clearance fit for the sleeve 1408. In a further example, the bit clamp 1402 includes a collet, a chuck or any other suitable bit clamp.

In another further example, a template 1212 with a through bore 1214 is at least temporarily fastened to the workpiece 1202 such that the through bore 1214 is positioned over the desired location 1204 on the work surface 1206. In this example, the power drill assembly 1103 also includes a retaining flange 1112 attached to the sleeve 1408 such that the sleeve 1408 and the retaining flange 1112 secure the gripper attachment 1104 to the power drill assembly 1103. The retaining flange 1112 includes a shoulder 1114 with a raised collar 1116 facing the template 1212 that fits within the through bore 1214. In this example, the moving 102 of the machine tool assembly 1100 includes moving 702 (see FIG. 7) the power drill assembly 1103 to the through bore 1214 of the template 1212 at the desired location 1204 on the work surface 1206 of the workpiece 1202. At 704, the raised collar 1116 of the sleeve 1408 is engaged with the through bore 1214 of the template 1212. Here, the activating 104 of the vacuum source 1702 draws a vacuum on the template 1212 and the work surface 1206 through the conformable foam seal 1106 and the gripper attachment 1104. The vacuum clamping 106 of the machine tool assembly 1100 includes vacuum clamping 706 the power drill assembly 1103 and the template 1212 to the work surface 1206 at the desired location 1204. In an even further example, a threaded end of the sleeve 1408 is inserted through the central bore 1504 of the gripper attachment 1104 for threaded engagement with the power drill 1300 to secure the sleeve 1408 to the power drill 1300. The flange 1112 is attached to an opposing end of the sleeve 1408 thereby securing the gripper attachment 1104 to the power drill 1300. In another even further example, with the sleeve 1408 attached to the power drill 1300, the gripper attachment 1104 is slid over the sleeve 1408 via the central bore 1504 and the flange is threaded on to the sleeve 1112 thereby securing the gripper attachment 1104 to the power drill 1300.

With reference again to FIGS. 1, 8, 11, 12, 14, 15 and 17, in one or more examples, a method 800 (see FIG. 8) for performing an operation on a workpiece 1202 includes the method 100 of FIG. 1. The method 800 continues from 106 of FIGS. 1 to 802 where a second vacuum source 1704 is activated to draw a second vacuum on the chip vacuum compartment 1522. At 804, the power drill assembly 1103 is activated and the drill bit 1406 is engaged with the work surface 1206 at the desired location 1204. At 806, the hole is drilled through the workpiece 1202 at the desired location 1204 using the power drill assembly 1103 and the drill bit 1406. At 808, debris resulting from the drilling of the hole is collected via the chip vacuum compartment 1522 based on the second vacuum drawn on the chip vacuum compartment 1522. In a further example, the second vacuum source 1704 includes a second vacuum pump, a second vacuum line to a facility vacuum system or any other suitable vacuum source in any suitable combination. In another example, the method 800 also includes deactivating 810 the power drill assembly 1103 after the hole is drilled. At 812, the vacuum drawn on the work surface 1206 is removed after the power drill assembly 1103 is deactivated. At 814, the power drill assembly 1103 is moved to a second desired location 1208 on the work surface 1206 of the workpiece 1202.

With reference again to FIGS. 1, 9, and 11-15, in still yet another example of the method 100, the machine tool assembly 1100 includes a power driver assembly 1105 and the operation to be performed on the workpiece 1202 includes removing a fastener from the workpiece 1202 at the desired location 1204. The power driver assembly 1105 includes a power driver 1118 with a bit clamp 1402 configured to selectively receive and secure a driver bit. The power driver assembly 1105 also includes a sleeve 1408 attached to the power driver 1118 over the bit clamp 1402. The sleeve 1408 providing a clearance fit to permit rotation of the bit clamp 1402. In this example, the gripper attachment 1104 defines a central bore 1504 extending from a second proximal end 1510 of the gripper attachment 1104 to a second distal end 1512 and a chip vacuum compartment 1522 in fluid communication with the central bore 1504. The central bore 1504 receiving the sleeve 1408 of the power driver assembly 1105. The sleeve 1408 includes multiple openings 1410 that provide fluid paths to the chip vacuum compartment 1522 for a fastener and debris resulting from the operation performed on the workpiece 1202. The conformable foam seal 1106 defines a hole 1108 aligned with the central bore 1504 of the gripper attachment 1104 to provide a clearance fit for the bit clamp 1402.

In a further example, the bit clamp 1402 includes a collet, a chuck or any other suitable bit clamp. In another further example, the driver bit includes a cross-tip screwdriver bit, a flat-tip screwdriver bit, a hex socket bit, a square socket bit, a hex head bit, a square head bit, a star head bit or any other suitable driver bit.

In yet another further example, the moving 102 of the machine tool assembly 1100 includes moving 902 (see FIG. 9) the power driver assembly 1105 to the desired location 1204 on the work surface 1206 of the workpiece 1202. In this example, the vacuum clamping 106 of the machine tool assembly 1100 includes vacuum clamping 904 the power driver assembly 1105 to the work surface 1206 at the desired location 1204.

With reference again to FIGS. 1, 10, 11, 12, 15 and 17, in one or more examples, a method 1000 (see FIG. 10) for performing an operation on a workpiece 1202 includes the method 100 of FIG. 1. The method 1000 continues from 106 of FIGS. 1 to 1002 where a second vacuum source 1704 is activated to draw a second vacuum on the chip vacuum compartment 1522. At 1004, the power driver assembly 1105 is activated and the driver bit is engaged with a head of the fastener at the desired location 1204 of the work surface 1206. At 1006, the fastener is removed from the workpiece 1202 at the desired location 1204 using the power driver assembly 1105 and the driver bit. At 1008, the fastener and the debris resulting from removal of the fastener are collected via the chip vacuum compartment 1522 based on the second vacuum drawn on the chip vacuum compartment 1522. In another example, the method 1000 also includes deactivating 1010 the power driver assembly 1105 after the fastener is removed. At 1012, the vacuum drawn on the work surface 1206 is removed after the power driver assembly 1105 is deactivated. At 1014, the power driver assembly 1105 is moved to a second desired location 1208 on the work surface 1206 of the workpiece 1202.

Referring generally to FIGS. 11-17, by way of examples, the present disclosure is directed to a machine tool assembly 1100 for performing an operation on a workpiece 1202. FIG. 11 is a perspective view of an example of the machine tool assembly 1100 with a machine tool 1102 and a gripper attachment 1104. FIG. 12 is a plan view showing portions of templates 1212 on a work surface 1206 of a workpiece 1202. FIG. 13 is a side view of an example of a machine tool 1102 of the machine tool assembly 1100. FIG. 14 is another side view of the machine tool 1102 showing an example of a sleeve 1408 that fits over a bit clamp 1402 with a working bit 1404. FIG. 15 is a cross-sectional view of an example of the gripper attachment 1104. FIG. 16 is a perspective view of an example of an articulated robot 1600 with the machine tool assembly 1100 on an end effector 1606 attached to a robotic arm 1604. FIG. 17 discloses a functional block diagram showing an example of the gripper attachment 1104 interconnected to a first (i.e., seal) vacuum source 1702 and a second (i.e., chip) vacuum source 1704 and posed facing the workpiece 1202.

Referring again to FIGS. 11-17, in one or more example, a machine tool assembly 1100 for performing an operation on a workpiece 1202 includes a machine tool 1102 and a gripper attachment 1104. The machine tool 1102 includes a housing 1302, a rotational drive 1308, a drive shaft 1310 and a bit clamp 1402. The housing 1302 defines a first proximal end 1304 and a first distal end 1306. The rotational drive 1308 is disposed within the housing 1302 to selectively provide a rotational force. The drive shaft 1310 coupled to the rotational drive 1308 to selectively rotate in response to the rotational force from the rotational drive 1308. The bit clamp 1402 attached to the drive shaft 1310 to rotate in response to the rotational force. The bit clamp 1402 configured to selectively receive and secure a working bit 1404. The gripper attachment 1104 affixed to the first distal end 1306 of the housing 1302 for the machine tool 1102. The gripper attachment 1104 includes a body 1502, a cover 1518 and a conformable foam seal 1106. The body 1502 defines a central bore 1504 and a seal vacuum compartment 1506. The central bore 1504 along a longitudinal axis 1508 extending from a second proximal end 1510 of the body 1502 to a second distal end 1512. The seal vacuum compartment 1506 isolated from the central bore 1504 and defining a seal vacuum port 1514 extending through the second proximal end 1510 of the body 1502. The seal vacuum compartment 1506 further defining an opening 1516 proximate the second distal end 1512 of the body 1502 that encircles the central bore 1504. The central bore 1504 receives the bit clamp 1402 of the machine tool 1102 at the second proximal end 1510 of the body 1502 and provides a clearance fit that permits rotation of the bit clamp 1402 within the central bore 1504. The cover 1518 attached to the body 1502 over the opening 1516 of the seal vacuum compartment 1506. The cover 1518 defining a plurality of apertures 1520 dispersed about an area of the cover 1518 over the opening 1516 to the seal vacuum compartment 1506. The conformable foam seal 1106 attached to the cover 1518 over the plurality of apertures 1520. The conformable foam seal 1106 defines a hole 1108 aligned with the central bore 1504 to provide a clearance fit for the bit clamp 1402.

In another example, the machine tool assembly 1100 includes a power drill assembly 1103, a power driver assembly 1105 or any other suitable machine tool assembly. In yet another example of the machine tool assembly 1100, the operation to be performed on the workpiece 1202 includes drilling a hole, removing a fastener or any other suitable operation. In still another example of the machine tool assembly 1100, the workpiece 1202 includes a composite workpiece, a metal workpiece or another other suitable workpiece in any suitable combination.

In still yet another example of the machine tool assembly 1100, the machine tool 1102 includes a power drill 1300, a power driver 1118 or any other suitable machine tool. In another example of the machine tool assembly 1100, the rotational drive 1308 includes an induction motor, a universal motor, a synchronous motor, a direct current motor, a brushless motor or any other suitable rotational drive. In yet another example of the machine tool assembly 1100, the bit clamp 1402 includes a collet, a chuck or any other suitable bit clamp. In still another example of the machine tool assembly 1100, the working bit 1404 includes a drill bit 1406, a cutting bit, a trimming bit, a routing bit, a sanding bit, a polishing bit, a driver bit or any other suitable working bit.

In still yet another example of the machine tool assembly 1100, the seal vacuum port 1514 is configured to interface with a vacuum source 1702 activation of which draws a vacuum on a work surface 1206 of the workpiece 1202 through the conformable foam seal 1106 and the gripper attachment 1104. In a further example, the vacuum source 1702 includes a vacuum pump, a vacuum line to a facility vacuum system or any other suitable vacuum source in any suitable combination. In another further example, the work surface 1206 of the workpiece 1202 includes a curved portion, a double curved portion, a contoured portion, a geometrically-shaped portion, a rising ramp portion, a falling ramp portion, a two-dimensional portion or any other suitable shaped portion in any suitable combination.

In another example of the machine tool assembly 1100, the plurality of apertures 1520 in the cover 1518 of the gripper attachment 1104 includes a plurality of holes, a plurality of openings, a plurality of slits, a plurality of perforations or any other suitable plurality of apertures in any suitable combination.

In yet another example of the machine tool assembly 1100, the conformable foam seal 1106 includes an open cell foam, a closed cell foam or any other suitable conformable foam in any suitable combination. In a further example, the open cell foam includes a polyurethane foam, a reticulated polyurethane foam, an open cell nitrile foam, an open cell polyvinyl chloride/nitrile foam, an open cell ethylene propylene diene monomer foam or any other suitable open cell foam in any suitable combination. In another further example, the closed cell foam includes a polyethylene foam, a polyvinyl chloride foam rubber, a closed cell polyvinyl chloride/nitrile foam, a closed cell ethylene propylene diene monomer foam rubber, an ethylene-vinyl acetate foam, an expanded polyethylene foam, a cross-linked polyethylene foam, a styrene butadiene rubber foam or any other suitable closed cell foam in any suitable combination. In yet another further example, where the conformable foam seal 1106 includes the closed cell foam, the conformable foam seal 1106 also includes a second plurality of apertures 1110 facing a work surface 1206 of the workpiece 1202 and aligned with the plurality of apertures 1520 in the cover 1518 of the gripper attachment 1104. In an even further example, the second plurality of apertures 1110 in the conformable foam seal 1106 of the gripper attachment 1104 include a plurality of holes, a plurality of openings, a plurality of slits, a plurality of perforations or any other suitable plurality of apertures in any suitable combination.

In still another example of the machine tool assembly 1100, the machine tool assembly 1100 is configured to be moved to a desired location 1204 on a work surface 1206 of the workpiece 1202 by an external control element. The conformable foam seal 1106 opposing the work surface 1206. The gripper attachment 1104 draws a vacuum on the work surface 1206 through the conformable foam seal 1106 in response to activation of a vacuum source 1702 and receipt of a vacuum draw at the seal vacuum port 1514. The gripper attachment 1104 vacuum clamps the machine tool assembly 1100 to the work surface 1206 at the desired location 1204 in response to the vacuum drawn on the work surface 1206. In a further example, the external control element includes an articulated robot 1600, a collaborative robot 1602, a robotic arm 1604, an operator or any other suitable external control element in any suitable combination.

In another further example, after the machine tool assembly 1100 is activated, the working bit 1404 received and secured in the bit clamp 1402 is engaged with the work surface 1206 of the workpiece 1202 at the desired location 1204. The machine tool assembly 1100 performs the operation on the work surface 1206 at the desired location 1204 using the working bit 1404 to change the workpiece 1202. In an even further example, the machine tool assembly 1100 is deactivated after the change is achieved. The vacuum drawn on the work surface 1206 is removed after the machine tool assembly 1100 is deactivated. The machine tool assembly 1100 is moved to a second desired location 1208 on the work surface 1206 of the workpiece 1202 after the vacuum is removed.

In yet another further example, the machine tool assembly 1100 is positioned by the gripper attachment 1104 to a normal orientation in relation to the desired location 1204 on the work surface 1206 of the workpiece 1202 in response to the vacuum drawn on the work surface 1206. The gripper attachment 1104 secures the machine tool assembly 1100 to the work surface 1206 in the normal orientation.

In still another further example, the machine tool assembly 1100 includes an end effector 1606 attached to a robotic arm 1604 of an articulated robot 1600. The desired location 1204 includes a predetermined location 1210 known to the articulated robot 1600. In conjunction with vacuum clamping the machine tool assembly 1100 to the work surface 1206, the robotic arm 1604 is positioned in response to the vacuum drawn on the work surface 1206 while the articulated robot 1600 is in a hand guiding mode. The machine tool assembly 1100 is adjusted to a normal orientation in relation to the predetermined location 1210 on the work surface 1206. The machine tool assembly 1100 is secured to the work surface 1206 in the normal orientation by the gripper attachment 1104 in response to the vacuum. In an even further example, the articulated robot 1600 includes a collaborative robot 1602.

In another even yet further example, the articulated robot 1600 controls: (1) activation of the machine tool assembly 1100 and engagement of the working bit 1404 of the machine tool assembly 1100 with the work surface 1206 of the workpiece 1202 at the desired location 1204; (2) performance of the operation on the work surface 1206 at the desired location 1204 using the machine tool assembly 1100 and the working bit 1404 to change the workpiece 1202; (3) deactivation of the machine tool assembly 1100 after the change is achieved; (4) removal of the vacuum drawn on the work surface 1206 after the machine tool assembly 1100 is deactivated; and (5) movement of the machine tool assembly 1100 to a second desired location 1208 on the work surface 1206 of the workpiece 1202.

In still yet another further example, the machine tool assembly 1100 includes a handheld machine tool assembly 1101. The handheld machine tool assembly 1101 is configured to be moved to the desired location 1204 on the work surface 1206 of the workpiece 1202 in response to an operator holding and positioning the handheld machine tool assembly 1101 to the desired location 1204. The vacuum source 1702 is activated in response to the operator turning on the vacuum source 1702 to draw the vacuum on the work surface 1206 while the operator continues holding the handheld machine tool assembly 1101 in position at the desired location 1204. In an even further example, after the handheld machine tool assembly 1101 is activated, the working bit 1404 received and secured in the bit clamp 1402 is engaged with the work surface 1206 of the workpiece 1202 at the desired location 1204. The handheld machine tool assembly 1101 performs the operation on the work surface 1206 at the desired location 1204 in response to the operator using the handheld machine tool assembly 1101 and the working bit 1404 to change the workpiece 1202. The handheld machine tool assembly 1101 is deactivated after the change is achieved in response to the operator turning off the handheld machine tool assembly 1101. The vacuum drawn on the work surface 1206 is removed after the handheld machine tool assembly 1101 is deactivated in response to the operator turning off the vacuum source 1702. The handheld machine tool assembly 1101 is moved to a second desired location 1208 on the work surface 1206 of the workpiece 1202 in response to the operator holding and positioning the handheld machine tool assembly 1101 to the second desired location 1208.

In another further example, the machine tool assembly 1100 includes a power drill assembly 1103 and the operation to be performed on the workpiece 1202 includes drilling a hole at the desired location 1204. The machine tool 1102 includes a power drill 1300. The working bit 1404 includes a drill bit 1406. The power drill assembly 1103 includes a sleeve 1408 attached to the power drill 1300 over the bit clamp 1402. The sleeve 1408 provides a clearance fit to permit rotation of the bit clamp 1402. In this example, the body 1502 of the gripper attachment 1104 defines a chip vacuum compartment 1522 in fluid communication with the central bore 1504. The chip vacuum compartment 1522 defining a chip vacuum port 1524 extending through the second proximal end 1510 of the body 1502. The central bore 1504 receiving the sleeve 1408 of the power drill assembly 1103. The sleeve 1408 includes multiple openings 1410 that provide fluid paths to the chip vacuum compartment 1522 for debris resulting from the operation performed on the workpiece 1202. The power drill assembly 1103 also includes a retaining flange 1112 attached to the sleeve 1408 such that the sleeve 1408 and the retaining flange 1112 secure the gripper attachment 1104 to the power drill assembly 1103.

The gripper attachment 1104 is affixed to the power drill assembly 1103 by a retaining flange 1112 that threads onto an end of the sleeve 1408 that extends through the central bore 1504.

In an even further example, in conjunction with the drilling of the hole at the desired location 1204, a template 1212 with a through bore 1214 is at least temporarily fastened to the workpiece 1202 such that the through bore 1214 is positioned over the desired location 1204 on the work surface 1206. The retaining flange 1112 includes a shoulder 1114 with a raised collar 1116 facing the template 1212 that fits within the through bore 1214. The power drill assembly 1103 is configured to be moved to the through bore 1214 of the template 1212 at the desired location 1204 on the work surface 1206 of the workpiece 1202. The raised collar 1116 of the retaining flange 1112 on the sleeve 1408 is engaged with the through bore 1214 of the template 1212. The gripper attachment 1104 draws the vacuum on the template 1212 and the work surface 1206 through the conformable foam seal 1106 in response to activation of the vacuum source 1702 and receipt of the vacuum draw at the seal vacuum port 1514. The gripper attachment 1104 clamps the power drill assembly 1103 and the template 1212 to the work surface 1206 at the desired location 1204 in response to the vacuum drawn on the work surface 1206.

In another even further example, the gripper attachment 1104 draws a second vacuum on the chip vacuum compartment 1522 in response to activation of a second vacuum source 1704 and receipt of a second vacuum draw at the chip vacuum port 1524. After the power drill assembly 1103 is activated, the drill bit 1406 is engaged with the work surface 1206 at the desired location 1204. The power drill assembly 1103 drills the hole through the workpiece 1202 at the desired location 1204 using the drill bit 1406. The chip vacuum compartment 1522 collects debris resulting from the drilling of the hole and passes the debris toward the second vacuum source 1704 based on the second vacuum drawn on the chip vacuum compartment 1522. In an even yet further example, the second vacuum source 1704 includes a second vacuum pump, a second vacuum line to a facility vacuum system or any other suitable vacuum source in any suitable combination. In another even yet further example, the debris is collected in a waste container 1706 associated with the second vacuum source 1704. In yet another even yet further example, the power drill assembly 1103 is deactivated after the hole is drilled. The vacuum drawn on the work surface 1206 is removed after the power drill assembly 1103 is deactivated. The power drill assembly 1103 is moved to a second desired location 1208 on the work surface 1206 of the workpiece 1202.

In another further example, the machine tool assembly 1100 includes a power driver assembly 1105 and the operation to be performed on the workpiece 1202 includes removing a fastener from the workpiece 1202 at the desired location 1204. The machine tool 1102 includes a power driver 1118. The working bit 1404 includes a driver bit. The power driver assembly 1105 includes a sleeve 1408 attached to the power driver 1118 over the bit clamp 1402. The sleeve 1408 provides a clearance fit to permit rotation of the bit clamp 1402. In this example, the body 1502 of the gripper attachment 1104 defines a chip vacuum compartment 1522 in fluid communication with the central bore 1504. The chip vacuum compartment 1522 defining a chip vacuum port 1524 extending through the second proximal end 1510 of the body 1502. The central bore 1504 receiving the sleeve 1408 of the power driver assembly 1105. The sleeve 1408 includes multiple openings 1410 that provide fluid paths to the chip vacuum compartment 1522 for a fastener and debris resulting from the operation performed on the workpiece 1202. The power driver assembly 1105 also includes a retaining flange 1112 attached to the sleeve 1408 such that the sleeve 1408 and the retaining flange 1112 secure the gripper attachment 1104 to the power driver assembly 1105. In an even further example, the driver bit includes a cross-tip screwdriver bit, a flat-tip screwdriver bit, a hex socket bit, a square socket bit, a hex head bit, a square head bit, a star head bit or any other suitable driver bit. In another even further example, the power driver assembly 1105 is configured to be moved to the desired location 1204 on the work surface 1206 of the workpiece 1202. The gripper attachment 1104 clamps the power driver assembly 1105 to the work surface 1206 at the desired location 1204 in response to the vacuum drawn on the work surface 1206.

In yet another further example, the gripper attachment 1104 draws a second vacuum on the chip vacuum compartment 1522 in response to activation of a second vacuum source 1704 and receipt of a second vacuum draw at the chip vacuum port 1524. After the power driver assembly 1105 is activated, the driver bit is engaged with a head of the fastener at the desired location 1204 of the work surface 1206. The power driver assembly 1105 removes the fastener from the workpiece 1202 at the desired location 1204 using the driver bit. The chip vacuum compartment 1522 collects the fastener and the debris resulting from removal of the fastener and passes the fastener and the debris toward the second vacuum source 1704 based on the vacuum drawn on the chip vacuum compartment 1522. In an even yet further example, the power driver assembly 1105 is deactivated after the fastener is removed. The vacuum drawn on the work surface 1206 is removed after the power driver assembly 1105 is deactivated. The power driver assembly 1105 is moved to a second desired location 1208 on the work surface 1206 of the workpiece 1202.

Referring generally to FIGS. 11-17, by way of examples, the present disclosure is directed to a gripper attachment 1104 for a machine tool assembly 1100. FIG. 11 is a perspective view of an example of the machine tool assembly 1100 with a machine tool 1102 and the gripper attachment 1104. FIG. 12 is a plan view showing portions of templates 1212 on a work surface 1206 of a workpiece 1202. FIG. 13 is a side view of an example of a machine tool 1102 of the machine tool assembly 1100. FIG. 14 is another side view of the machine tool 1102 showing an example of a sleeve 1408 that fits over a bit clamp 1402 with a working bit 1404. FIG. 15 is a cross-sectional view of an example of the gripper attachment 1104. FIG. 16 is a perspective view of an example of an articulated robot 1600 with the machine tool assembly 1100 on an end effector 1606 attached to a robotic arm 1604. FIG. 17 discloses a functional block diagram showing an example of the gripper attachment 1104 interconnected to a first (i.e., seal) vacuum source 1702 and a second (i.e., chip) vacuum source 1704 and posed facing the workpiece 1202.

With reference again to FIGS. 11-17, in one or more example, a gripper attachment 1104 for a machine tool assembly 1100 includes a body 1502, a cover 1518 and a conformable foam seal 1106. The a body 1502 defining a central bore 1504 and a seal vacuum compartment 1506. The central bore 1504 along a longitudinal axis 1508 extending from a proximal end 1510 of the body 1502 to a distal end 1512. The seal vacuum compartment 1506 isolated from the central bore 1504 and defining a seal vacuum port 1514 extending through the proximal end 1510 of the body 1502. The seal vacuum compartment 1506 further defining an opening 1516 proximate the distal end 1512 of the body 1502 that encircles the central bore 1504. The central bore 1504 configured to receive a bit clamp 1402 on a machine tool 1102 of the machine tool assembly 1100 at the proximal end 1510 of the body 1502 and providing a clearance fit that permits rotation of the bit clamp 1402 within the central bore 1504. The bit clamp 1402 configured to selectively receive and secure a working bit 1404. The cover 1518 attached to the body 1502 over the opening 1516 of the seal vacuum compartment 1506. The cover 1518 defining a plurality of apertures 1520 dispersed about an area of the cover 1518 over the opening 1516 to the seal vacuum compartment 1506. The conformable foam seal 1106 attached to the cover 1518 over the plurality of apertures 1520 and configured to face a work surface 1206 of a workpiece 1202 upon which the machine tool assembly 1100 is configured to perform an operation. The conformable foam seal 1106 defines a hole 1108 aligned with the central bore 1504 to provide a clearance fit for the bit clamp 1402.

In another example, the gripper attachment 1104 is configured to be affixed to a second distal end 1306 of a housing 1302 for the machine tool 1102. In yet another example of the gripper attachment 1104, the machine tool assembly 1100 includes a power drill assembly 1103, a power driver assembly 1105 or any other suitable machine tool assembly.

In still another example of the gripper attachment 1104, the seal vacuum port 1514 is configured to interface with a vacuum source 1702 activation of which draws a vacuum on a work surface 1206 of the workpiece 1202 through the conformable foam seal 1106 and the gripper attachment 1104. In a further example, the vacuum source 1702 includes a vacuum pump, a vacuum line to a facility vacuum system or any other suitable vacuum source in any suitable combination.

In still yet another example of the gripper attachment 1104, the bit clamp 1402 includes a collet, a chuck or any other suitable bit clamp. In another example of the gripper attachment 1104, the machine tool 1102 includes a power drill 1300, a power driver 1118 or any other suitable machine tool. In yet another example of the gripper attachment 1104, the plurality of apertures 1520 in the cover 1518 includes a plurality of holes, a plurality of openings, a plurality of slits, a plurality of perforations or any other suitable plurality of apertures in any suitable combination.

In still another example of the gripper attachment 1104, the conformable foam seal 1106 includes an open cell foam, a closed cell foam or any other suitable conformable foam in any suitable combination. In a further example, the open cell foam includes a polyurethane foam, a reticulated polyurethane foam, an open cell nitrile foam, an open cell polyvinyl chloride/nitrile foam, an open cell ethylene propylene diene monomer foam or any other suitable open cell foam in any suitable combination. In another further example, the closed cell foam includes a polyethylene foam, a polyvinyl chloride foam rubber, a closed cell polyvinyl chloride/nitrile foam, a closed cell ethylene propylene diene monomer foam rubber, an ethylene-vinyl acetate foam, an expanded polyethylene foam, a cross-linked polyethylene foam, a styrene butadiene rubber foam or any other suitable closed cell foam in any suitable combination. In an even further example, where the conformable foam seal 1106 includes the closed cell foam, the conformable foam seal 1106 also includes a second plurality of apertures 1110 facing a work surface 1206 of the workpiece 1202 and aligned with the plurality of apertures 1520 in the cover 1518. In an even yet further example, the second plurality of apertures 1110 in the conformable foam seal 1106 include a plurality of holes, a plurality of openings, a plurality of slits, a plurality of perforations or any other suitable plurality of apertures in any suitable combination.

In still yet another example of the gripper attachment 1104, the operation to be performed on the workpiece 1202 includes drilling a hole, removing a fastener or any other suitable operation.

In another example of the gripper attachment 1104, the machine tool assembly 1100 is configured to be moved to a desired location 1204 on a work surface 1206 of the workpiece 1202 by an external control element. The conformable foam seal 1106 opposing the work surface 1206. The gripper attachment 1104 draws a vacuum on the work surface 1206 through the conformable foam seal 1106 in response to activation of a vacuum source 1702 and receipt of a vacuum draw at the seal vacuum port 1514. The gripper attachment 1104 vacuum clamps the machine tool assembly 1100 to the work surface 1206 at the desired location 1204 in response to the vacuum drawn on the work surface 1206.

In a further example, the machine tool assembly 1100 is positioned by the gripper attachment 1104 to a normal orientation in relation to the desired location 1204 on the work surface 1206 of the workpiece 1202 in response to the vacuum drawn on the work surface 1206. The gripper attachment 1104 secures the machine tool assembly 1100 to the work surface 1206 in the normal orientation.

In another further example, the machine tool assembly 1100 includes an end effector 1606 attached to a robotic arm 1604 of an articulated robot 1600. The desired location 1204 includes a predetermined location 1210 known to the articulated robot 1600. In conjunction with vacuum clamping the machine tool assembly 1100 to the work surface 1206, the robotic arm 1604 is positioned in response to the vacuum drawn on the work surface 1206 while the articulated robot 1600 is in a hand guiding mode. The machine tool assembly 1100 is adjusted to a normal orientation in relation to the predetermined location 1210 on the work surface 1206. The machine tool assembly 1100 is secured to the work surface 1206 in the normal orientation by the gripper attachment 1104 in response to the vacuum. In an even further example, the articulated robot 1600 includes a collaborative robot 1602.

In yet another further example, the machine tool assembly 1100 includes a power drill assembly 1103 and the operation to be performed on the workpiece 1202 includes drilling a hole at the desired location 1204. The machine tool 1102 includes a power drill 1300. The working bit 1404 includes a drill bit 1406. The power drill assembly 1103 includes a sleeve 1408 attached to the power drill 1300 over the bit clamp 1402. The sleeve 1408 providing a clearance fit to permit rotation of the bit clamp 1402. In this example, the body 1502 defines a chip vacuum compartment 1522 in fluid communication with the central bore 1504. The chip vacuum compartment 1522 defining a chip vacuum port 1524 extending through the proximal end 1510 of the body 1502. The central bore 1504 receiving the sleeve 1408 of the power drill assembly 1103. The sleeve 1408 includes multiple openings 1410 that provide fluid paths to the chip vacuum compartment 1522 for debris resulting from the operation performed on the workpiece 1202. The power drill assembly 1103 also includes a retaining flange 1112 attached to the sleeve 1408 such that the sleeve 1408 and the retaining flange 1112 secure the gripper attachment 1104 to the power drill assembly 1103.

In an even further example, in conjunction with the drilling of the hole at the desired location 1204, a template 1212 with a through bore 1214 is at least temporarily fastened to the workpiece 1202 such that the through bore 1214 is positioned over the desired location 1204 on the work surface 1206. The retaining flange 1112 includes a shoulder 1114 with a raised collar 1116 facing the template 1212 that fits within the through bore 1214. The power drill assembly 1103 is configured to be moved to the through bore 1214 of the template 1212 at the desired location 1204 on the work surface 1206 of the workpiece 1202. The raised collar 1116 of the retaining flange 1112 on the sleeve 1408 is engaged with the through bore 1214 of the template 1212. The gripper attachment 1104 draws the vacuum on the template 1212 and the work surface 1206 through the conformable foam seal 1106 in response to activation of the vacuum source 1702 and receipt of the vacuum draw at the seal vacuum port 1514. The gripper attachment 1104 clamps the power drill assembly 1103 and the template 1212 to the work surface 1206 at the desired location 1204 in response to the vacuum drawn on the work surface 1206.

In another even further example, the gripper attachment 1104 draws a second vacuum on the chip vacuum compartment 1522 in response to activation of a second vacuum source 1704 and receipt of a second vacuum draw at the chip vacuum port 1524. After the power drill assembly 1103 is activated, the drill bit 1406 is engaged with the work surface 1206 at the desired location 1204. The power drill assembly 1103 drills the hole through the workpiece 1202 at the desired location 1204 using the drill bit 1406. The chip vacuum compartment 1522 collects debris resulting from the drilling of the hole and passes the debris toward the second vacuum source 1704 based on the second vacuum drawn on the chip vacuum compartment 1522. In an even yet further example, the second vacuum source 1704 includes a second vacuum pump, a second vacuum line to a facility vacuum system or any other suitable vacuum source in any suitable combination. In another even yet further example, the debris is collected in a waste container 1706 associated with the second vacuum source 1704.

In still another further example, the machine tool assembly 1100 includes a power driver assembly 1105 and the operation to be performed on the workpiece 1202 includes removing a fastener from the workpiece 1202 at the desired location 1204. The machine tool 1102 includes a power driver 1118. The working bit 1404 includes a driver bit. The power driver assembly 1105 includes a sleeve 1408 attached to the power driver 1118 over the bit clamp 1402. The sleeve 1408 provides a clearance fit to permit rotation of the bit clamp 1402. In this example, the gripper attachment 1104 defines a chip vacuum compartment 1522 in fluid communication with the central bore 1504. The chip vacuum compartment 1522 defining a chip vacuum port 1524 extending through the proximal end 1510 of the body 1502. The central bore 1504 receiving the sleeve 1408 of the power driver assembly 1105. The sleeve 1408 includes multiple openings 1410 that provide fluid paths to the chip vacuum compartment 1522 for a fastener and debris resulting from the operation performed on the workpiece 1202. The power driver assembly 1105 also includes a retaining flange 1112 attached to the sleeve 1408 such that the sleeve 1408 and the retaining flange 1112 secure the gripper attachment 1104 to the power driver assembly 1105.

In an even further example, the power driver assembly 1105 is configured to be moved to the desired location 1204 on the work surface 1206 of the workpiece 1202. The gripper attachment 1104 clamps the power driver assembly 1105 to the work surface 1206 at the desired location 1204 in response to the vacuum drawn on the work surface 1206.

In another even further example, the gripper attachment 1104 draws a second vacuum on the chip vacuum compartment 1522 in response to activation of a second vacuum source 1704 and receipt of a second vacuum draw at the chip vacuum port 1524. After the power driver assembly 1105 is activated, the driver bit is engaged with a head of the fastener at the desired location 1204 of the work surface 1206. The power driver assembly 1105 removes the fastener from the workpiece 1202 at the desired location 1204 using the driver bit. The chip vacuum compartment 1522 collects the fastener and the debris resulting from removal of the fastener and passes the fastener and the debris toward the second vacuum source 1704 based on the vacuum drawn on the chip vacuum compartment 1522.

Examples of the methods 100, 400, 600, 800, 1000 for performing an operation on a workpiece 1202, the machine tool assemblies 1100 for performing an operation on a workpiece 1202, and the gripper attachments 1104 for the machine tool assemblies 1100 may be related to or used in the context of aircraft manufacturing. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may be implemented to produce components and other equipment in various types of vehicles and in the construction of various types of buildings.

The preceding detailed description refers to the accompanying drawings, which illustrate specific examples described by the present disclosure. Other examples having different structures and operations do not depart from the scope of the present disclosure. Like reference numerals may refer to the same feature, element or component in the different drawings. Throughout the present disclosure, any one of a plurality of items may be referred to individually as the item and a plurality of items may be referred to collectively as the items and may be referred to with like reference numerals. Moreover, as used herein, a feature, element, component or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic and/or operational step described in connection with the example is included in at least one aspect, embodiment and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component or hardware “configured to” perform a specified function is indeed capable of performing the specified function without any alteration, rather than merely having potential to perform the specified function after further modification. In other words, the system, apparatus, device, structure, article, element, component or hardware “configured to” perform a specified function is specifically selected, created, implemented, utilized, programmed and/or designed for the purpose of performing the specified function. As used herein, “configured to” denotes existing characteristics of a system, apparatus, structure, article, element, component or hardware that enable the system, apparatus, structure, article, element, component or hardware to perform the specified function without further modification. For purposes of this disclosure, a system, apparatus, device, structure, article, element, component or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels and are not intended to impose ordinal, positional or hierarchical requirements on the items to which these terms refer. Moreover, reference to, e.g., a “second” item does not require or preclude the existence of, e.g., a “first” or lower-numbered item and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B and item C” may include, without limitation, item A or item A and item B. This example also may include item A, item B and item C or item B and item C. In other examples, “at least one of” may be, for example, without limitation, two of item A, one of item B and ten of item C; four of item B and seven of item C; and other suitable combinations. As used herein, the term “and/or” and the “/” symbol includes any and all combinations of one or more of the associated listed items.

As used herein, the terms “coupled,” “coupling,” and similar terms refer to two or more elements that are joined, linked, fastened, attached, connected, put in communication or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

In FIGS. 1-10, referred to above, the blocks may represent operations, steps and/or portions thereof and lines connecting the various blocks do not imply any particular order or dependency of the operations or portions thereof. It will be understood that not all dependencies among the various disclosed operations are necessarily represented. FIGS. 1-10 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

In FIGS. 11-17, referred to above, may represent functional elements, features or components thereof and do not necessarily imply any particular structure. Accordingly, modifications, additions and/or omissions may be made to the illustrated structure. Additionally, those skilled in the art will appreciate that not all elements, features and/or components described and illustrated in FIGS. 11-17, referred to above, need be included in every example and not all elements, features and/or components described herein are necessarily depicted in each illustrative example. Accordingly, some of the elements, features and/or components described and illustrated in FIGS. 11-17 may be combined in various ways without the need to include other features described and illustrated in FIGS. 11-17, other drawing figures and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 11-17, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features and/or components that serve a similar, or at least substantially similar, purpose are labeled with like numbers in each of FIGS. 11-17 and such elements, features and/or components may not be discussed in detail herein with reference to each of FIGS. 11-17. Similarly, all elements, features and/or components may not be labeled in each of FIGS. 11-17, but reference numerals associated therewith may be utilized herein for consistency.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage or characteristic described in connection with an example is included in at least one example. Thus, discussion of features, advantages and similar language used throughout the present disclosure may, but does not necessarily, refer to the same example.

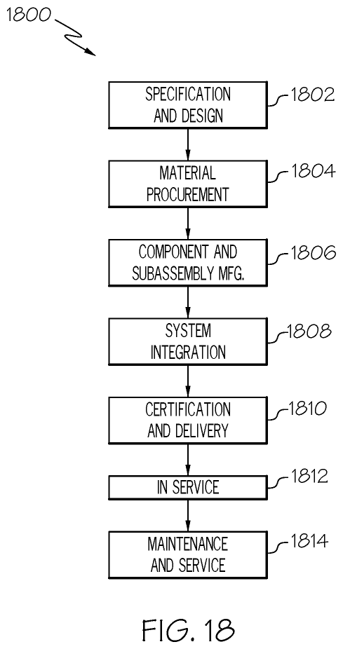

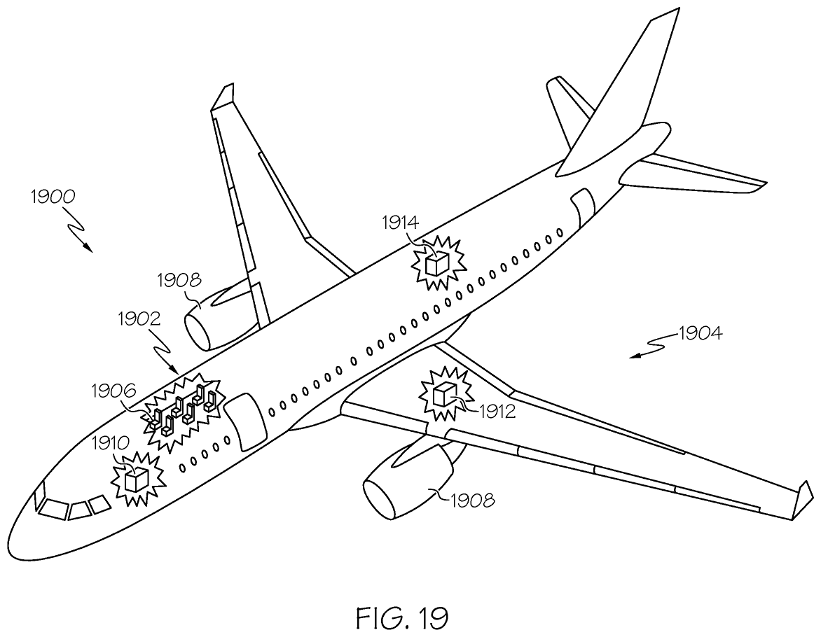

Examples of the subject matter disclosed herein may be described in the context of aircraft manufacturing and service method 1800 as shown in FIG. 18 and aircraft 1900 as shown in FIG. 19. In one or more examples, the disclosed methods and systems for associating test data for a part under test with an end item coordinate system may be used in aircraft manufacturing. During pre-production, the service method 1800 may include specification and design (block 1802) of aircraft 1900 and material procurement (block 1804). During production, component and subassembly manufacturing (block 1806) and system integration (block 1808) of aircraft 1900 may take place. Thereafter, aircraft 1900 may go through certification and delivery (block 1810) to be placed in service (block 1812). While in service, aircraft 1900 may be scheduled for routine maintenance and service (block 1814). Routine maintenance and service may include modification, reconfiguration, refurbishment, etc. of one or more systems of aircraft 1900.

Each of the processes of the service method 1800 may be performed or carried out by a system integrator, a third party and/or an operator (e.g., a customer). For the purposes of this description, a system integrator may include, without limitation, any number of aircraft manufacturers and major-system subcontractors; a third party may include, without limitation, any number of vendors, subcontractors and suppliers; and an operator may be an airline, leasing company, military entity, service organization and so on.

As shown in FIG. 19, aircraft 1900 produced by the service method 1800 may include airframe 1902 with a plurality of high-level systems 1904 and interior 1906. Examples of high-level systems 1904 include one or more of propulsion system 1908, electrical system 1910, hydraulic system 1912 and environmental system 1914. Any number of other systems may be included. Although an aerospace example is shown, the principles disclosed herein may be applied to other industries, such as the automotive industry. Accordingly, in addition to aircraft 1900, the principles disclosed herein may apply to other vehicles, e.g., land vehicles, marine vehicles, space vehicles, etc.

The disclosed systems and methods for associating test data for a part under test with an end item coordinate system may be employed during any one or more of the stages of the manufacturing and service method 1800. For example, components or subassemblies corresponding to component and subassembly manufacturing (block 1806) may be fabricated or manufactured in a manner similar to components or subassemblies produced while aircraft 1900 is in service (block 1812). Also, one or more examples of the system(s), method(s) or combination thereof may be utilized during production stages (block 1806 and block 1808), for example, by substantially expediting assembly of or reducing the cost of aircraft 1900. Similarly, one or more examples of the system or method realizations or a combination thereof, may be utilized, for example and without limitation, while aircraft 1900 is in service (block 1812) and/or during maintenance and service (block 1814).

The described features, advantages and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the methods 100, 400, 600, 800, 1000 for performing an operation on a workpiece 1202, the machine tool assemblies 1100 for performing an operation on a workpiece 1202, and the gripper attachments 1104 for the machine tool assemblies 1100 have been shown and described, modifications may occur to those skilled in the art upon reading the specification. The present application includes such modifications and is limited only by the scope of the claims.

1. A method for performing an operation on a workpiece, the method comprising:
moving a machine tool assembly to a desired location on a work surface of the workpiece, the machine tool assembly defining a proximal end and a distal end and comprising a gripper attachment affixed to the distal end, the gripper attachment comprising a conformable foam seal opposing the work surface;
activating a vacuum source to draw a vacuum on the work surface through the conformable foam seal and the gripper attachment; and
vacuum clamping the machine tool assembly to the work surface at the desired location in response to the vacuum drawn on the work surface.

2. The method of claim 1 wherein the operation to be performed on the workpiece comprises at least one of drilling a hole and removing a fastener.

3. The method of claim 1 wherein the workpiece comprises at least one of a composite workpiece and a metal workpiece.

4. The method of claim 1 wherein the machine tool assembly comprises at least one of a power drill assembly and a power driver assembly.

5. The method of claim 1 wherein the work surface of the workpiece comprises at least one of a curved portion, a double curved portion, a contoured portion, a geometrically-shaped portion, a rising ramp portion, a falling ramp portion and a two-dimensional portion.

6. The method of claim 1 wherein the conformable foam seal comprises at least one of an open cell foam and a closed cell foam.

7-10. (canceled)

11. The method of claim 1 wherein the gripper attachment defines a seal vacuum compartment in fluid communication with the vacuum source and the conformable foam seal in conjunction with drawing the vacuum on the work surface.

12. The method of claim 1, further comprising:
activating the machine tool assembly and engaging a working bit of the machine tool assembly with the work surface of the workpiece at the desired location; and
performing the operation on the work surface at the desired location using the machine tool assembly and the working bit to change the workpiece.

13-14. (canceled)

15. The method of claim 1, the vacuum clamping of the machine tool assembly comprising:
positioning the machine tool assembly to a normal orientation in relation to the desired location on the work surface of the workpiece in response to the vacuum drawn on the work surface; and
securing the machine tool assembly to the work surface in the normal orientation.

16. The method of claim 1 wherein the machine tool assembly comprises an end effector attached to a robotic arm of an articulated robot, and
wherein the desired location comprises a predetermined location known to the articulated robot, and
wherein the vacuum clamping of the machine tool assembly comprises:
positioning of the robotic arm while the articulated robot is in a hand guiding mode;
adjusting the machine tool assembly to a normal orientation in relation to the predetermined location on the work surface; and
securing the machine tool assembly to the work surface in the normal orientation.

17-18. (canceled)

19. The method of claim 1 wherein the machine tool assembly comprises a handheld machine tool assembly, and
wherein the moving of the machine tool assembly comprises:
moving the handheld machine tool assembly to the desired location on the work surface of the workpiece in response to an operator holding and positioning the handheld machine tool assembly to the desired location, and
wherein the activating of the vacuum source comprises:
activating the vacuum source in response to the operator turning on the vacuum source to draw the vacuum on the work surface while the operator continues holding the handheld machine tool assembly in position at the desired location.

20. (canceled)

21. The method of claim 1 wherein the machine tool assembly comprises a power drill assembly and the operation to be performed on the workpiece comprises drilling a hole at the desired location, wherein the power drill assembly comprises a power drill with a bit clamp configured to selectively receive and secure a drill bit, wherein the power drill assembly further comprises a sleeve attached to the power drill over the bit clamp, the sleeve providing a clearance fit to permit rotation of the bit clamp, and
wherein the gripper attachment defines a central bore extending from a second proximal end of the gripper attachment to a second distal end and a chip vacuum compartment in fluid communication with the central bore, the central bore receiving the sleeve of the power drill assembly, the sleeve comprising multiple openings that provide fluid paths to the chip vacuum compartment for debris resulting from the operation performed on the workpiece, and
wherein the conformable foam seal defines a hole aligned with the central bore of the gripper attachment to provide a clearance fit for the sleeve.

22. (canceled)

23. The method of claim 21 wherein a template with a through bore is at least temporarily fastened to the workpiece such that the through bore is positioned over the desired location on the work surface, wherein the power drill assembly further comprises a retaining flange attached to the sleeve such that the sleeve and the retaining flange secure the gripper attachment to the power drill assembly, the retaining flange comprising a shoulder with a raised collar facing the template that fits within the through bore, the moving of the machine tool assembly comprising:
moving the power drill assembly to the through bore of the template at the desired location on the work surface of the workpiece; and
engaging the raised collar of the sleeve with the through bore of the template, and
wherein the activating of the vacuum source draws a vacuum on the template and the work surface through the conformable foam seal and the gripper attachment, and
wherein the vacuum clamping of the machine tool assembly comprises:
vacuum clamping the power drill assembly and the template to the work surface at the desired location.

24-25. (canceled)

26. The method of claim 21, further comprising:
activating a second vacuum source to draw a second vacuum on the chip vacuum compartment;
activating the power drill assembly and engaging the drill bit with the work surface at the desired location;
drilling the hole through the workpiece at the desired location using the power drill assembly and the drill bit; and
collecting the debris resulting from the drilling of the hole via the chip vacuum compartment based on the second vacuum drawn on the chip vacuum compartment.

27. The method of claim 26 wherein the second vacuum source comprises at least one of a second vacuum pump and a second vacuum line to a facility vacuum system.

28. The method of claim 26, further comprising:
deactivating the power drill assembly after the hole is drilled;
removing the vacuum drawn on the work surface after the power drill assembly is deactivated; and
moving the power drill assembly to a second desired location on the work surface of the workpiece.

29. The method of claim 1 wherein the machine tool assembly comprises a power driver assembly and the operation to be performed on the workpiece comprises removing a fastener from the workpiece at the desired location, wherein the power driver assembly comprises a power driver with a bit clamp configured to selectively receive and secure a driver bit, wherein the power driver assembly further comprises a sleeve attached to the power driver over the bit clamp, the sleeve providing a clearance fit to permit rotation of the bit clamp, and
wherein the gripper attachment defines a central bore extending from a second proximal end of the gripper attachment to a second distal end and a chip vacuum compartment in fluid communication with the central bore, the central bore receiving the sleeve of the power driver assembly, the sleeve comprising multiple openings that provide fluid paths to the chip vacuum compartment for a fastener and debris resulting from the operation performed on the workpiece, and
wherein the conformable foam seal defines a hole aligned with the central bore of the gripper attachment to provide a clearance fit for the bit clamp.

30-32. (canceled)

33. The method of claim 29, further comprising:
activating a second vacuum source to draw a second vacuum on the chip vacuum compartment;
activating the power driver assembly and engaging the driver bit with a head of the fastener at the desired location of the work surface;
removing the fastener from the workpiece at the desired location using the power driver assembly and the driver bit; and
collecting the fastener and the debris resulting from removal of the fastener via the chip vacuum compartment based on the second vacuum drawn on the chip vacuum compartment.

34. (canceled)

35. A machine tool assembly for performing an operation on a workpiece, comprising:
a machine tool comprising:
a housing defining a first proximal end and a first distal end;
a rotational drive disposed within the housing that selectively provides a rotational force;
a drive shaft coupled to the rotational drive that selectively rotates in response to the rotational force from the rotational drive; and
a bit clamp attached to the drive shaft that rotates in response to the rotational force, the bit clamp configured to selectively receive and secure a working bit; and
a gripper attachment affixed to the first distal end of the housing for the machine tool, the gripper attachment comprising:
a body defining a central bore and a seal vacuum compartment, the central bore along a longitudinal axis extending from a second proximal end of the body to a second distal end, the seal vacuum compartment isolated from the central bore and defining a seal vacuum port extending through the second proximal end of the body, the seal vacuum compartment further defining an opening proximate the second distal end of the body that encircles the central bore, the central bore receiving the bit clamp of the machine tool at the second proximal end of the body and providing a clearance fit that permits rotation of the bit clamp within the central bore;
a cover attached to the body over the opening of the seal vacuum compartment, the cover defining a plurality of apertures dispersed about an area of the cover over the opening to the seal vacuum compartment; and
a conformable foam seal attached to the cover over the plurality of apertures, the conformable foam seal defining a hole aligned with the central bore to provide a clearance fit for the bit clamp.

36-72. (canceled)

73. A gripper attachment for a machine tool assembly, comprising:
a body defining a central bore and a seal vacuum compartment, the central bore along a longitudinal axis extending from a proximal end of the body to a distal end, the seal vacuum compartment isolated from the central bore and defining a seal vacuum port extending through the proximal end of the body the seal vacuum compartment further defining an opening proximate the distal end of the body that encircles the central bore, the central bore configured to receive a bit clamp on a machine tool of the machine tool assembly at the proximal end of the body and providing a clearance fit that permits rotation of the bit clamp within the central bore, the bit clamp configured to selectively receive and secure a working bit;
a cover attached to the body over the opening of the seal vacuum compartment, the cover defining a plurality of apertures dispersed about an area of the cover over the opening to the seal vacuum compartment; and
a conformable foam seal attached to the cover over the plurality of apertures and configured to face a work surface of a workpiece upon which the machine tool assembly is configured to perform an operation, the conformable foam seal defining a hole aligned with the central bore to provide a clearance fit for the bit clamp.

74-98. (canceled)
